(19) United States
(12) Patent Application Publication
(10) Pub. No.: US 2015/0129607 A1
(43) Pub. Date: May 14, 2015

(54) ENERGY SAVING HOT TANK FOR WATER COOLER

(71) Applicant: MTN Products, Inc, La Verne, CA (US)

(72) Inventors: Chun - Yen Wang, El Paso, TX (US); Kejun Wei, GuangDong (CN)

(73) Assignee: MTN Products, Inc, La Verne, CA (US)

(21) Appl. No.: 14/079,678

(22) Filed: Nov. 14, 2013

(51) Int. Cl. B67D 3/00; B67D 7/80

(52) U.S. Cl. CPC B67D 3/0061; B67D 3/0009; B67D 3/0022; B67D 3/0038; B67D 7/80
USPC 222/67; 222/146.1

(57) ABSTRACT

An energy efficient water cooler assembly and/or liquid dispensing apparatus and method for using same, including an energy-saving baffle, which may take the form of a conventional or bottom load water cooler, and which may be either gravity-driven or pump-fed.

### PATENT INCORPORATED BY REFERENCE

Commonly-assigned U.S. Pat. No. 8,356,731, titled “Energy Saving Baffle For Water Cooler,” issued Jan. 22, 2013, is incorporated by reference in its entirety into this disclosure, including but not limited to the energy saving baffle disclosure of FIGS. 27-29 and the corresponding text relating to those drawings (14:13-15:32).

### BACKGROUND OF THE INVENTION

The present invention generally relates to water cooler assemblies and liquid dispensing apparatus. More specifically, the invention relates to an energy saving hot water tank used in such assemblies and apparatus.

Using a water cooler assembly with a cold tank on top and a hot tank beneath it has been known for decades. Energy consumption for such past water cooler assemblies has been in the range of about 2 kilowatt-hours/day. EPA regulations effective Jan. 22, 2010 require energy consumption of less than about 1.2 kW-h/day to properly label a product as “Energy Star.” The EPA guidelines can be met by taking steps such as using heavy insulation (such as vacuum-insulated walls for the hot tank) and rerouting water from the bottom of the hot tank.

Energy consumption tests conducted by the present inventors and separately analyzing the cold system, and the hot system, showed that energy consumed by the separate systems was substantially less than the combined system, allowing the present inventors to conclude that the cold/hot system interaction has a substantial impact on energy consumption, perhaps as much as 30%.

The present inventors also found that placing a restrictor in the baffle within the pathway between the cold and hot tanks, as disclosed in commonly-assigned U.S. Pat. No. 8,356,731, reduced energy loss to about 1.1 kWh/day). The present inventors also found that using pump-fed rather than gravity systems further reduced energy consumption to about 0.7-0.8 kW-h/day. Pump-fed systems use longer tubing in between the hot and cold tanks, allowing water in this tubing, during an idle stage, to more closely equalize in temperature before it travels to an the adjacent tank, requiring less frequent running of the cold and hot systems, and correspondingly lower energy consumption.

It would be advantageous to design a water cooler assembly and water dispensing apparatus that is more energy efficient than those currently available for gravity-fed systems, and comparable in energy efficiency to pump-fed systems.

### SUMMARY OF THE INVENTION

The objects mentioned above, as well as other objects, are solved by the present invention, which overcomes disadvantages of prior water cooler assemblies and liquid dispensing apparatus, while providing new advantages not believed associated with such assemblies and apparatus.

In a preferred embodiment of the invention, a liquid dispensing apparatus is provided, including cold and hot tanks in liquid communication with each other and with a dispensing faucet. A baffle is housed within the cold tank, and separates liquid within the cold tank into two or more regions having differing temperatures. A baffle tube allows liquid within the cold tank adjacent the baffle to move between the cold and hot tanks. Preferably, the baffle tube houses a restrictor, such as a floating restrictor (e.g., a hollow ball) with a specific density less than the specific density of the liquid. In this embodiment, the restrictor normally floats upward within the baffle tube to partially seal against an upper retaining member within the baffle tube and thereby restrict liquid circulation between the hot and cold tanks. Preferably, a non-metal gasket, such as a silicone gasket, forms a thermal barrier between liquid within the baffle tube, the cold tank, and an intake portion of the hot tank.

In a particularly preferred embodiment, the hot tank is located below the cold tank, and following liquid discharge from the hot tank, the restrictor is pushed downwardly within the baffle tube, to a lowermost position below a bottom edge of the cold tank, by liquid flowing from the cold tank to replenish the hot tank. The floating restrictor, when at its lowermost range below the bottom edge of the cold tank, may be contained by a non-metal compartment.

The invention may be used with either gravity-driven dispensing systems (e.g., a traditional water cooler using an inverted water bottle), or pump-fed dispensing systems.

In an alternative embodiment, a liquid dispensing apparatus is provided with cold and hot tanks in liquid communication with each other and with a dispensing faucet, and a baffle housed within the cold tank, which separates two or more regions of liquid in the cold tank having differing temperatures. A baffle tube may be used to allow liquid within the cold tank adjacent the baffle to move between the cold and hot tanks. The baffle tube may house a floating restrictor with a specific density less than the specific density of the liquid. The restrictor may normally float upward within the baffle tube to partially seal against an upper retaining member within the baffle tube and thereby restrict liquid circulation between the hot and cold tanks. Preferably, the hot tank is located below the cold tank. Following liquid discharge from the hot tank, the restrictor is pushed downwardly within the baffle tube, to a lowermost position below a bottom edge of the cold tank, by liquid flowing from the cold tank to replenish the hot tank. In this alternative embodiment, the baffle tube may include a baffle stem portion, which may have an inner diameter substantially greater than 10 mm, such as a about 14 mm. The baffle tube may also include a snap-on adaptor which press-fits into a baffle nut which fastens to an intake portion of the hot tank.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a front and side perspective view of a bottom load water cooler of the prior art;

FIG. 2 is a perspective view of a preferred embodiment of the invention; and

FIG. 3 is an enlarged, sectional view of an alternative embodiment of the invention; and

FIG. 4 is a partial perspective and cross-sectional view of the embodiment shown in FIG. 3.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

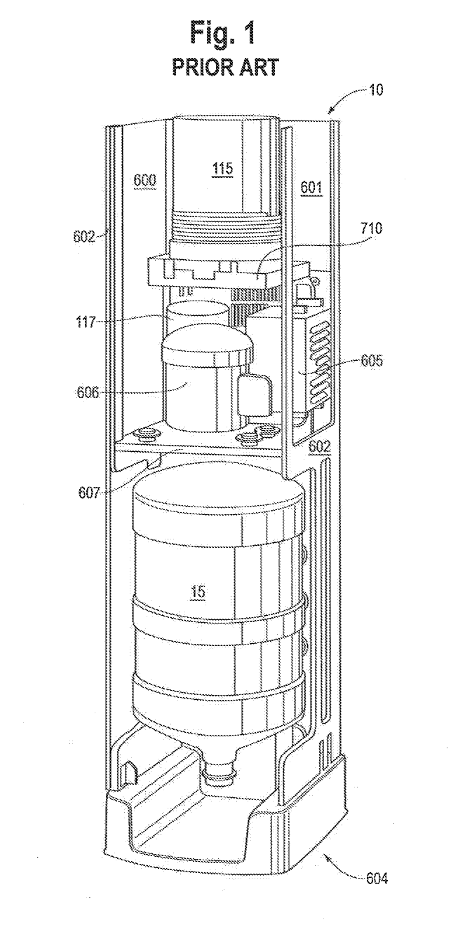

Referring first to FIG. 1, a bottom load water cooler assembly, generally referred to by reference numeral 10, is shown. Water cooler assembly 10 includes an enclosure 604 with side panels 600, side frames 602, and rear top panel 601, housing an inverted water bottle 15, a cold tank 115 which may rest on bracket 710, and as hot tank 117 located below the cold tank; the hot tank may rest on center shelf 607. Compressor 606 may also rest on center shelf 607.

The water cooler assembly 10 shown in FIG. 1 sources water using a pump fed system (not shown), either from water bottle 15 or from a pressurized source from a municipal or other water supply. Alternatively, a gravity-driven dispensing system may be used, using a water bottle located above the cold and hot tanks.

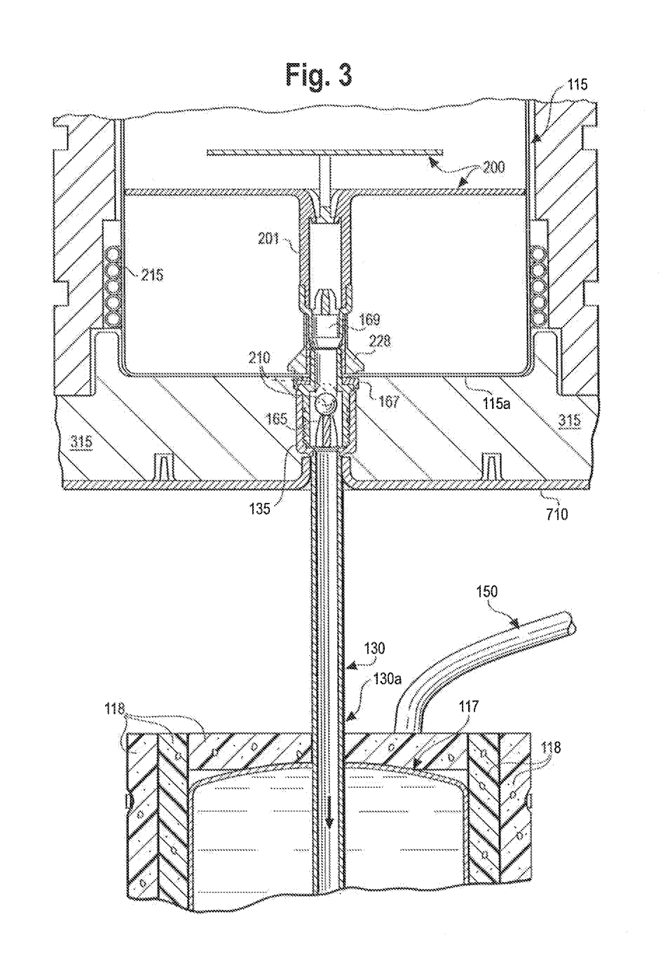

Preferably, a restrictor (e.g., a floating ball) moving within a baffle system, as disclosed in U.S. Pat. No. 8,356,731, is used for energy efficiency purposes (i.e., to control convection losses in the pathway between the hot and cold tanks). Hot tank 117 should also be covered with insulation 118 (FIG. 3), such as polyethylene foam, while cold tank 115 may be covered with insulation 315 such as styrofoam.

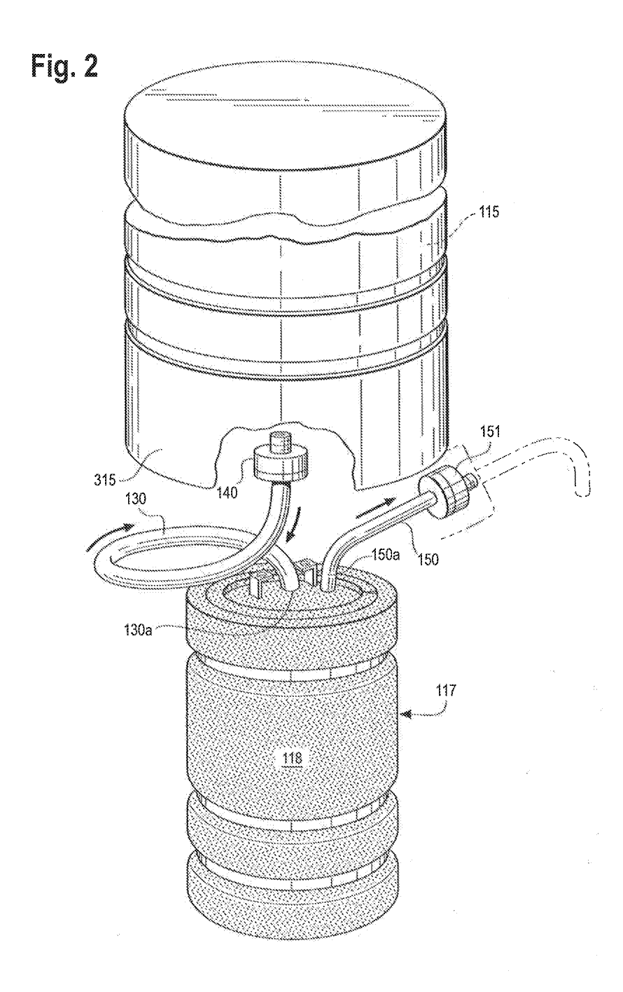

Referring now to FIG. 2, spiral tubing 130 is preferably used between hot water tank 117 and cold water tank 115 for cold water flowing from the cold tank into the hot tank. Refrigerant tubing 215 (FIG. 3) may be provided around the circumference of cold tank 115, as is well known in the art. The longer water pathway distance provided by the spiral tubing enhances energy efficiency in the pathway between the hot and cold tanks, as mentioned above. An exemplary, uncoiled length for spiral tubing 130 of the present invention is between about 1-2 feet, and more preferably between about 15-16 inches. By using a spiral shape, the lengthened tubing can be made to fit into a tight space, as desired.

Still referring to FIG. 2, both the inlet portion 130a of tubing 130 (water from the cold tank traveling into the hot tank), and the outlet portion 150a of tubing 150 (water from the hot tank traveling directly, and which may be connected by hot water outlet thread portion 151 to the faucet or dispensing nozzle) may be stainless steel which is welded directly on to the hot tank, and need not be detachable.

Referring to both alternative embodiments shown in FIGS. 2-3, hot water intake thread portion 140 (which may be welded or otherwise connected to tubing 130) is preferably now made from plastic rather than metal (plastic is a much poorer conductor of heat or cold than metal), reducing the energy loss by preventing the hot tank metal portion from directly contacting cold water from cold tank 115 traveling through tubing 130. In more detail, tubing 130 preferably includes an enlarged passageway 140 accommodating plastic hot tank intake thread piece 165 and a silicone gasket 167 to thermally separate direct contact between water from the cold tank and metal hot tank intake threaded piece 135. As shown, because the lower portion of plastic hot tank intake thread piece 165 is in the hot water zone (cold tank Styrofoam insulation 315 is located below the cold tank, as shown in FIG. 3, and the area above the bottom of the cold tank is the zone separation point), if thread piece 165 were made of metal, it will more easily conduct heat up to the cold tank through the water in tubing 130, causing energy losses. Conversely, because the upper portion of gasket 167 is in the cold water zone, if it were metal, once it is chilled in the cold water zone, it will conduct cold temperatures down to the hot tank more easily, causing thermal losses.

Referring now to FIG. 3, a baffle 200, similar to the baffle shown and described in FIGS. 27-29 of U.S. Pat. No. 8,356,731, and utilizing floating ball/restrictor 210, movable within baffle tube 201, may be located in cold tank 115. (The ball or other restrictor normally floats upward within baffle tube 201 to partially seal against an upper retaining member within the baffle tube and thereby restrict liquid circulation between the hot and cold tanks; when a dispensing user discharges liquid from the hot tank, the ball may be pushed downwardly by liquid flowing from the cold tank to replenish the hot tank.) Baffle nut 228 may be used, and works like a screw nut to: (a) thread onto the end of intake thread portion 140 in the FIG. 2 embodiment; or (b) thread onto the end of plastic hot tank intake thread portion 165 in the FIG. 3 embodiment. In either case, this helps secure the cold tank in place, while also preventing vertical movement of baffle 200 during use.

Referring to the FIG. 3 embodiment, plastic hot tank intake thread piece 165, in turn, may thread into metal hot water intake thread portion 135 (Which may be welded or otherwise attached to tubing 130); the interior portion of plastic thread piece 165 serves to contain the restrictor 210 at its lowest position. Gasket 167, such as a silicone gasket, is preferably used and serves to thermally separate direct contact between plastic intake thread portion 165 and cold tank 115.

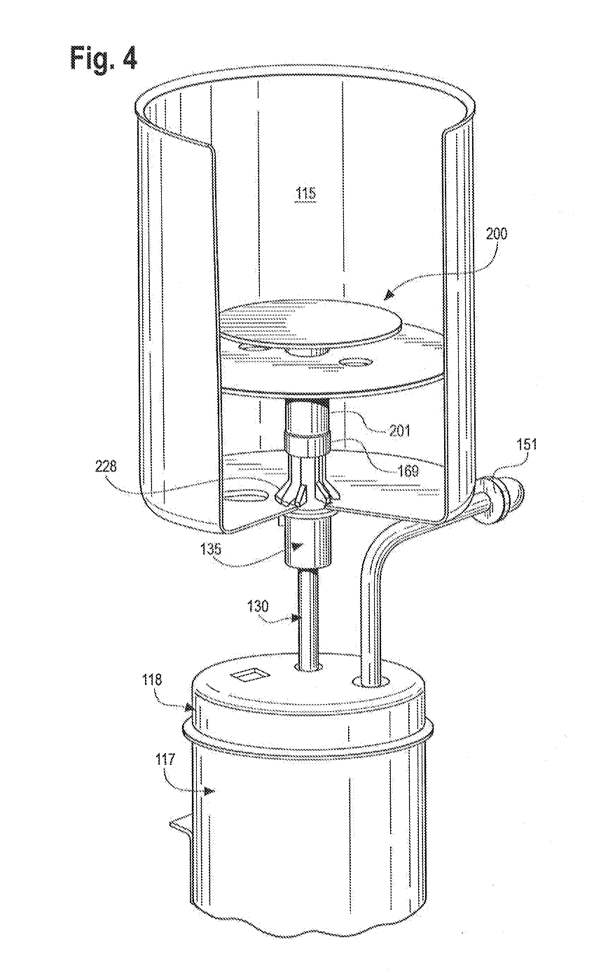

Referring now to FIGS. 3-4, in the preferred embodiment shown there, baffle stem portion 201 snaps on snap-on adaptor 169, and adaptor 169 in turn press-fits into baffle nut 228. Adaptor 169 enables an increase in the inner diameter of stem portion 201, while fitting into baffle nut 228, permitting an adequate flow rate. Using this approach, a 14 mm range inner diameter for stem portion 201 may be provided; in contrast, the corresponding ID for the original baffle shown in U.S. Pat. No. 8,356,731 is about 10 mm, or nearly a 100% cross-sectional area increase in the area for water to flow through.

Referring to FIG. 3, as compared to its location at FIGS. 27-29 of U.S. Pat. No. 8,356,731 (in Which the lowermost location of floating ball 540 is above the bottom edge of cold tank 505, as shown in FIG. 28B of the '731 patent), the lowermost position of floating ball 210 has been relocated to a lower location, below the bottom wall 115A of cold tank 115. This relocation allows the cold water in baffle stem portion 201 to be restricted so that it remains in the cold water zone. Floating ball 210 is now located at the top edge of the hot water zone, the interface between cold and hot zone, to best separate the hot and cold water in baffle tube 201.

As a non-limiting example, for explanatory purposes, when floating ball 210 is in its uppermost position, the cold zone temperature may be close to the cold tank temperature of about, for example, 10° C., Similarly, the hot zone temperature may be close to the hot tank temperature of about, for example, 85° C. However, this assumes little or no water exchange. In reality, water can still move up and down so the cold and hot zone temperature separation is not a clear cut line, but rather a band.

Accordingly, by using a plastic hot tank intake thread piece 165, in conjunction with a new, lowered location for restrictor (e.g. floating ball) 210, a straight cold/hot zone separation line is now formed at the bottom of the cold tank, as represented by the opposed arrows on FIG. 3.

As noted above, FIGS. 2 and 3 are alternative embodiments. Using the spiral tubing (130) approach of FIG. 2, floating ball 210 need not be moved down to the location illustrated in FIG. 3 but, instead, can remain inside the baffle 200. Also, with the FIG. 2 embodiment, intake thread portion 165 need not be plastic, and the shape of thread portion 135 need not be changed to mate with thread portion 165. Conversely, these changes are made in the FIG. 3 embodiment to accommodate the fact that spiral tubing is not used.

The above description is not intended to limit the meaning of the words used in the following claims that define the invention. Other systems, methods, features, and advantages of the present invention will be, or will become, apparent to one having ordinary skill in the art upon examination of the foregoing drawings, written description and claims, and persons of ordinary skill in the art will understand that a variety of other designs still failing within the scope of the following claims may be envisioned and used. For example, consumable liquids other than water, such as but not limited to carbonated beverages, may be dispensed. It is contemplated that these or other future modifications in structure, function or result will exist that are not substantial changes and that all such insubstantial changes in what is claimed are intended to be covered by the claims.

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

1. A liquid dispensing apparatus, comprising:
cold and hot tanks in liquid communication with each other and with a dispensing faucet;
a baffle housed within the cold tank, the baffle separating two or more regions of liquid in the cold tank having differing temperatures;
a baffle tube allowing liquid within the cold tank adjacent the baffle to move between the cold and hot tanks, the baffle tube housing a floating restrictor with a specific density less than the specific density of the liquid, wherein the restrictor normally floats upward within the baffle tube to partially seal against an upper retaining member within the baffle tube and thereby restrict liquid circulation between the hot and cold tanks; and
a non-metal compartment co/meeting the hot tube and an intake portion of the hot tank, wherein the non-metal compartment forms a thermal barrier between. liquid within the baffle tube, the cold tank, and the intake portion of the hot tank.

2. The liquid dispensing apparatus of claim 1, further comprising a silicone gasket located to act as a thermal barrier between the intake portion of the hot tank and the cold tank.

3. The liquid dispensing apparatus of claim 1, wherein the hot tank is located below the cold tank, and following liquid discharge from the hot tank, the restrictor is pushed downwardly within the baffle tube, to a lowermost position below a bottom edge of the cold tank, by liquid flowing from the cold tank to replenish the hot tank.

4. The liquid dispensing apparatus of claim 1, wherein the floating restrictor comprises a hollow ball.

5. The liquid dispensing apparatus of claim 1, further comprising spiral-shaped tubing in liquid communication between the cold and hot tanks,

6. The liquid dispensing apparatus of claim 5, wherein the spiral-shaped tubing has an uncoiled length of between about 1-2 feet.

7. The liquid dispensing apparatus of claim 3, wherein the floating restrictor, when at its lowermost range below the bottom edge of the cold tank, is contained within the a non-metal compartment.

8. The liquid dispensing apparatus of claim 3, wherein the floating restrictor, when positioned at its lowermost position below the bottom edge of the cold tank, is located below a thermal separation zone between cold and hot water.

9. The liquid dispensing apparatus of claim 1, wherein the apparatus is a pump-fed dispensing system.

10. The liquid dispensing apparatus of claim 1, wherein the apparatus is a gravity-driven dispensing system using an inverted water bottle.

11. A liquid dispensing apparatus, comprising:
cold and hot tanks in liquid communication with each other and with a dispensing faucet;
a baffle housed within the cold tank, the baffle separating two or more regions of liquid in the cold tank having differing temperatures;
a baffle tube allowing liquid within the cold tank adjacent the baffle to move between the cold and hot tanks, the baffle tube housing a floating restrictor with a specific density less than the specific density of the liquid, wherein the restrictor normally floats upward within the baffle tube to partially seal against an upper retaining member within the baffle tube and thereby restrict liquid circulation between the hot and cold tanks;
wherein the hot tank is located below the cold tank, and following liquid discharge from the hot tank, the restrictor is pushed downwardly within the baffle tube, to a lowermost position below a bottom edge of the cold tank, by liquid flowing from the cold tank to replenish the hot tank.

12. The dispensing apparatus of claim 11, wherein the baffle tube further comprises a baffle stem portion.

13. The dispensing apparatus of claim 12, wherein the inner diameter of the baffle stem portion is substantially greater than 10 mm.

14. The dispensing apparatus of claim 11, wherein the baffle tube further comprises a non-metal, snap-on adaptor which is engaged by a baffle nut and fastens to an intake portion of the hot tank.
